(19) United States
(12) Patent Application Publication
(10) Pub. No.: US 2021/0054924 A1
(43) Pub. Date: Feb. 25, 2021

(54) DIAL TRANSMISSION LEVER DEVICE

(71) Applicant: KYUNG CHANG INDUSTRIAL CO., Ltd., Dalseo-gu (KR)

(72) Inventors: Dong Won KIM, Dalseong-gun (KR); Sung Joon Maeng, Dalseo-gu (KR); Hyeong Seok Hong, Dalseong-gun (KR)

(21) Appl. No.: 16/928,580

(22) Filed: Jul. 14, 2020

(30) Foreign Application Priority Data
Aug. 20, 2019 (KR) 10-2019-0101467

(51) Int. Cl. F16H 59/12; F16H 61/02; F16H 61/24; F16H 59/02; F16H 59/08

(52) U.S. Cl. CPC F16H 59/12; F16H 61/0204; F16H 2059/081; F16H 59/0208; F16H 61/24

(57) ABSTRACT

A dial transmission lever device according to an exemplary embodiment of the present invention includes a dial knob, a button guide unit, a plurality of button units, a rubber unit, and a board unit. The dial knob is rotatable from a predetermined reference position and includes a first hole that penetrates the dial knob from one end to the other end of the dial knob. The button guide unit is disposed in the dial knob. The plurality of button units is disposed in the button guide unit. The rubber unit is disposed below the button guide unit and includes protruding portions disposed below the plurality of button units, respectively. The board unit is disposed below the rubber unit. In addition, the dial knob further includes a rotary member disposed in the first hole, coupled to the dial knob, and configured to rotate together with the dial knob.

### CROSS-REFERENCE TO RELATED APPLICATIONS

This application claims priority to and the benefit of Korean Patent Application No. 10-2019-0101467 filed in the Korean Intellectual Property Office on Aug. 20, 2019, the entire contents of which are incorporated herein by reference.

### TECHNICAL FIELD

The present invention relates to a transmission lever device, and more particularly, to a dial transmission lever device provided with a dial knob to be rotated to select a gear shift position of a vehicle.

### BACKGROUND ART

The present invention relates to a dial transmission lever device of a transmission for an SBW vehicle. When a driver holds a dial knob of the dial transmission lever device and rotates the dial knob by applying physical force to the dial knob, a mechanical change is made, so that gears of the vehicle are changed. For providing the driver with convenience, the dial knob is rotated in one direction to change the gears, and after being rotated in one direction, the dial knob is returned to the original position by being rotated in the other direction.

However, in the case of such a rotary transmission device used to implement gear shift positions (P, R, N, and D positions) of the vehicle, product price competitiveness deteriorates and product functions or both performances and user's sensibility cannot be satisfied because of problems of increase in the number of components and difficulty in managing components and productivity.

Therefore, there is a need for solving the above-mentioned problems and developing new types of technologies different from those in the related art. Further, there is a need for providing a user with a convenient use method and a high-quality product.

[Document of Related Art] [Patent Document] (Patent Document 1) Korean Patent No. 1906444 (published on Oct. 11, 2018)

### SUMMARY OF THE INVENTION

The present invention has been made in an effort to provide a dial transmission lever device having a dial knob to be rotated to select a gear shift position of a vehicle.

The present invention has also been made in an effort to provide a dial transmission lever device that uses a rubber or metal dome sheet, instead of a bullet in the related art, in order to implement operating feeling (sense of shifting gears).

However, the object of the present invention is not limited to the above-mentioned objects but may be variously expanded without departing from the spirit and scope of the present invention.

An exemplary embodiment of the present invention provides a dial transmission lever device including a dial knob, a button guide unit, a plurality of button units, a rubber unit, and a board unit. The dial knob is rotatable from a predetermined reference position and includes a first hole that penetrates the dial knob from one end to the other end of the dial knob. The button guide unit is disposed in the dial knob. The plurality of button units is disposed in the button guide unit. The rubber unit is disposed below the button guide unit and includes protruding portions disposed below the plurality of button units, respectively. The board unit is disposed below the rubber unit. In addition, the dial knob further includes a rotary member disposed in the first hole, coupled to the dial knob, and configured to rotate together with the dial knob. When the dial knob is rotated, the rotary member presses the button unit, the button unit is moved downward, the button unit moved downward presses the protruding portion of the rubber unit, and the pressed protruding portion is elastically deformed and comes into switch-contact with the board unit disposed below the rubber unit, such that an electrical signal is generated, and a gear shift position of a vehicle is selected based on the electrical signal.

According to the exemplary embodiment, the pressed protruding portion is elastically deformed and elastically restored, thereby creating operating feeling.

Another exemplary embodiment of the present invention provides a dial transmission lever device including a dial knob, a button guide unit, a plurality of button units, a rubber unit, a board unit, and a detection unit. The dial knob is rotatable from a predetermined reference position and includes a first hole that penetrates the dial knob from one end to the other end of the dial knob. The button guide unit is disposed in the dial knob. The plurality of button units is disposed in the button guide unit. The rubber unit is disposed below the button guide unit and includes protruding portions disposed below the plurality of button units, respectively. The board unit is disposed below the rubber unit. The detection unit includes a magnet disposed on the dial knob, and a sensor disposed on the board unit and configured to detect a magnetic field of the magnet. When the dial knob is rotated, the magnet disposed on the dial knob is rotated, a magnetic field detected by the sensor changes in accordance with the rotation of the magnet, and a gear shift position of a vehicle is selected by using the change in detected magnetic field.

According to the exemplary embodiment, the dial knob includes a rotary member disposed in the first hole, coupled to the dial knob, and configured to rotate together with the dial knob. When the dial knob is rotated, the rotary member presses the button unit, the button unit moves downward, the button unit moved downward presses the protruding portion of the rubber unit, and the pressed protruding portion is elastically deformed and elastically restored to create operating feeling.

According to the exemplary embodiment, the button guide unit includes an inner wall and an outer wall, and one or more holes, which penetrate the button guide unit in a longitudinal direction of the button guide unit, are formed in the inner wall. The outer wall is formed to surround the inner wall and disposed to be spaced apart from the inner wall at a predetermined interval so that a groove is formed between the inner wall and the outer wall. A plurality of partition walls, which protrudes in a direction orthogonal to an outer surface of the outer wall, is formed in a partial section of the outer surface of the outer wall, and the plurality of partition walls is disposed constantly at predetermined intervals. The button unit is disposed between one partition wall and another partition wall adjacent to one partition wall.

According to the exemplary embodiment, the plurality of button units includes a first button unit, and a second button unit disposed to be spaced apart from one side of the first button unit at a predetermined distance. An upper portion of the first button unit is formed in a triangular shape, and an upper portion of the second button unit is increased in height from the left to the right. When a pressing portion of the rotary member is disposed between the upper portion of the first button unit and the upper portion of the second button unit and the dial knob is rotated in one direction, the pressing portion comes into contact with the upper portion of the second button unit and moves from the left to the right to press the second button unit, the pressed second button unit moves downward, the second button unit moved downward presses the protruding portion of the rubber unit disposed below the second button unit, and the pressed protruding portion is elastically deformed and then elastically restored.

According to the exemplary embodiment, the plurality of button units further includes a third button unit disposed to be spaced apart from the other side of the first button unit at a predetermined distance. The upper portion of the third button unit is decreased in height from the left to the right. When the pressing portion of the rotary member is disposed between the upper portion of the first button unit and the upper portion of the third button unit and the dial knob is rotated in the other direction, the pressing portion comes into contact with the upper portion of the second button unit and moves from the right to the left to press the third button unit, the pressed third button unit moves downward, the third button unit moved downward presses the protruding portion of the rubber unit disposed below the third button unit, and the pressed protruding portion is elastically deformed and then elastically restored.

According to the exemplary embodiment, the dial transmission lever device further includes a push assembly disposed in the first hole of the dial knob. The push assembly includes a push unit, a push guide unit, and a damper unit. The push unit is exposed to the outside. A push guide unit includes a second hole in which the push unit is disposed, and the push guide unit is disposed in the button guide unit and moves vertically together with the push unit. A damper unit is disposed below a catching portion of the push guide unit. When the push unit is pressed, the push unit and the push guide unit move downward, the catching portion comes into contact with the damper unit to press the damper unit, the pressed damper unit moves downward to press the button unit disposed below the damper unit, the pressed button unit moves downward to press the protruding portion of the rubber unit disposed below the button unit, and the pressed protruding portion is elastically deformed and comes into switch-contact with the board unit disposed below the rubber unit, such that an electrical signal is generated, and a gear shift position is selected by the pressing operation of the push unit based on the electrical signal.

According to the exemplary embodiment, the push assembly further includes a first light transmission member or a second light transmission member. The first light transmission member is disposed below the push unit and disposed in the second hole of the push guide unit. The second light transmission member is disposed below the push unit and disposed in a through hole of the first light transmission member. When the push unit is pressed or a vehicle operates, the first light transmission member transmits light, which is emitted from a light emitting element disposed on the board unit, to the push unit. When the push unit is pressed, the second light transmission member transmits light, which is emitted from the light emitting element disposed on the board unit, to a display window of the push unit, such that a gear shift position made by the pressing operation of the push unit is displayed on the display window.

According to the exemplary embodiment, the board unit is a metal dome sheet including a metal dome, and the metal dome is disposed below the protruding portion of the rubber unit. When the metal dome is pressed as the pressed protruding portion is elastically deformed, the protruding portion and the metal dome come into switch-contact with each other, such that an electrical signal is generated, and a gear shift position designated for the button unit is selected by the electrical signal.

According to the exemplary embodiment, the metal dome sheet creates operating feeling by elasticity of a board when the button unit is pressed.

According to the exemplary embodiment, one or more protrusions configured to prevent a clearance are formed on the dial knob.

According to the exemplary embodiment, the dial transmission lever device further includes a mood member, and a third light transmission member disposed below the mood member. The mood member may be disposed in a hole formed in an upper surface of a housing. The mood member has a ring shape, and the dial knob is penetratively disposed in the ring shape. When a gear shift position of the vehicle is selected, the third light transmission member transmits light, which is emitted from a light emitting element disposed on the board unit, to the mood member to illuminate the mood member.

According to the dial transmission lever device according to the exemplary embodiment of the present invention, the dial knob is rotated at a predetermined angle, such that operating feeling (sense of shifting gears) may be implemented and the gear shift positions of the vehicle may be changed.

In the present invention, since the dial knob is rotated to select the gear shift position of the vehicle, the number of components of the product may be small, the product clearance may be small, and the product may be reduced in size.

However, the effect of the present invention is not limited to the above-mentioned effects but may be variously expanded without departing from the spirit and scope of the present invention.

### BRIEF DESCRIPTION OF THE DRAWINGS

FIGS. 1A, 1B are views illustrating a dial transmission lever device according to an exemplary embodiment of the present invention.

FIG. 2 is an exploded perspective view of the dial transmission lever device illustrated in FIGS. 1A, 1B.

FIGS. 3A, 3B are views illustrating a dial knob illustrated in FIG. 2.

FIG. 4 is a view illustrating a rotary member illustrated in FIG. 2.

FIGS. 5A, 5B are views illustrating a button guide unit illustrated in FIG. 2.

FIGS. 6A-6C are views illustrating a plurality of button units illustrated in FIG. 2.

FIG. 7 is a view illustrating a state in which the rotary member, the button guide unit, and the plurality of button units, which are illustrated in FIG. 2, are combined.

FIGS. 8A-8C are views for explaining an operational principle of a dial assembly illustrated in FIG. 2.

FIG. 9 is a view illustrating a push assembly illustrated in FIG. 2.

FIG. 10 is a view illustrating a board unit illustrated in FIG. 2.

FIG. 11 is a view for explaining a pattern in which a gear shift position is selected by an operation of the dial knob illustrated in FIG. 2.

### DETAILED DESCRIPTION

Hereinafter, exemplary embodiments of the present invention will be described in more detail with reference to the accompanying drawings. The specific description of constituent elements of the present invention will be omitted in order not to obscure the subject matter of the present invention if the constituent elements can be easily reproduced and clearly understand, from the related art, by those skilled in the art.

Hereinafter, a dial transmission lever device 10 according to exemplary embodiments of the present invention will be described.

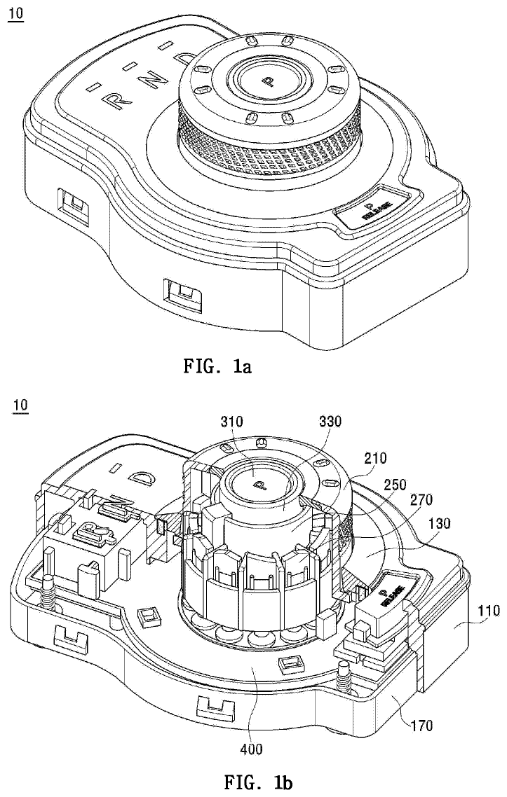

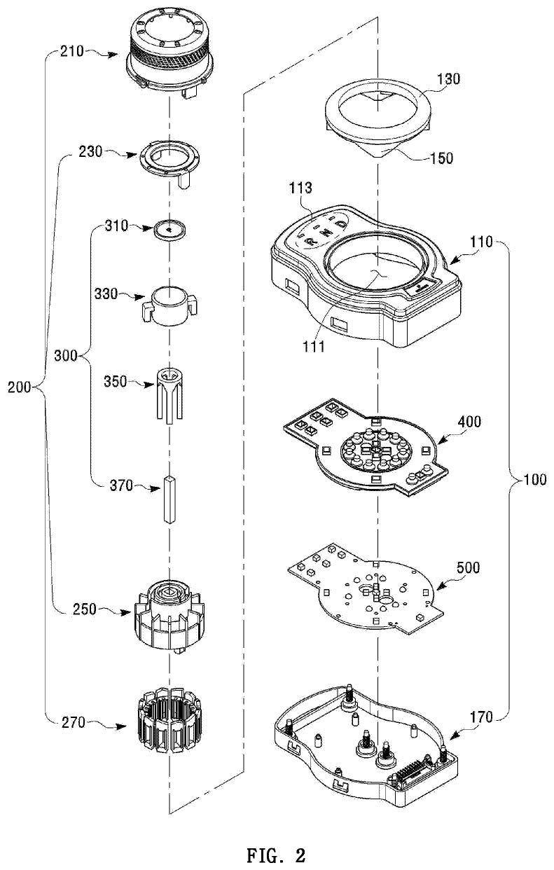

FIGS. 1A, 1B are views illustrating the dial transmission lever device according to the exemplary embodiment of the present invention. FIG. 1A is a perspective view illustrating the dial transmission lever device 10 according to the exemplary embodiment of the present invention, and FIG. 1B is a perspective view illustrating a part of an internal configuration of the dial transmission lever device 10 illustrated in FIG. 1A. FIG. 2 is an exploded perspective view of the dial transmission lever device 10 illustrated in FIGS. 1A, 1B.

Referring to FIGS. 1A, B and 2, the dial transmission lever device 10 according to the exemplary embodiment of the present invention includes a housing 100, a dial assembly 200, a push assembly 300, a rubber unit 400, a board unit 500, and a detection unit. Here, the dial assembly 200 includes a dial knob 210, a rotary member 230, a button guide unit 250, and a plurality of button units 270. The push assembly 300 includes a push unit 310, a push guide unit 330, and damper units 334a and 334b. The respective constituent elements will be specifically described below.

<Housing>

The housing 100 defines an external appearance of the transmission lever device 10 according to the exemplary embodiment of the present invention.

The housing 100 is mounted in a vehicle and has an internal space that receives various types of constituent elements of the transmission lever device 10 according to the exemplary embodiment of the present invention.

The housing 100 may be formed by combining the several separated constituent components. Specifically, the housing 100 includes upper and lower housings 110 and 170 separated from each other, and the housing 100 may be formed by combining the upper housing 110 and the lower housing 170.

A method of combining the upper housing 110 and the lower housing 170 is not particularly limited. For example, it is possible to adopt various methods such as a bolting method or a hook fastening method that combines the upper housing 110 and the lower housing 170 by fitting a protruding portion (or hole) or groove (recess) formed on a lateral surface of the upper housing 110 with a hole or groove (or protruding portion) formed on a lateral surface of the lower housing 170.

An internal shape of the housing 100 is not particularly limited. The housing 100 may have therein receiving portions that may receive various types of constituent elements that constitute the transmission lever device 10. The housing 100 may have various shapes so as to fix and combine various types of constituent elements.

An external shape of the housing 100 is not particularly limited. The housing 100 may have various shapes so as to fix and combine various types of constituent elements that constitute the transmission lever device 10.

The upper housing 110 of the transmission lever device 10 according to the exemplary embodiment of the present invention includes an upper surface. The upper surface may be a flat surface or a surface including a curved or stepped portion in accordance with the exemplary embodiment of the present invention.

A hole 111 may be formed in the upper surface of the upper housing 110. The dial knob 210 to be described below may penetrate the hole 111. A shape of the hole 111, when viewed from above, is not particularly limited, and the hole 111 may have various shapes that enable the dial knob 210 to be disposed and rotated therein.

A display window 113 may be disposed on the upper housing 110 of the transmission lever device 10 according to the exemplary embodiment of the present invention. When a user rotates the dial knob 210 and selects a gear shift position, the display window 113 may display the selected gear shift position.

<Dial Assembly>

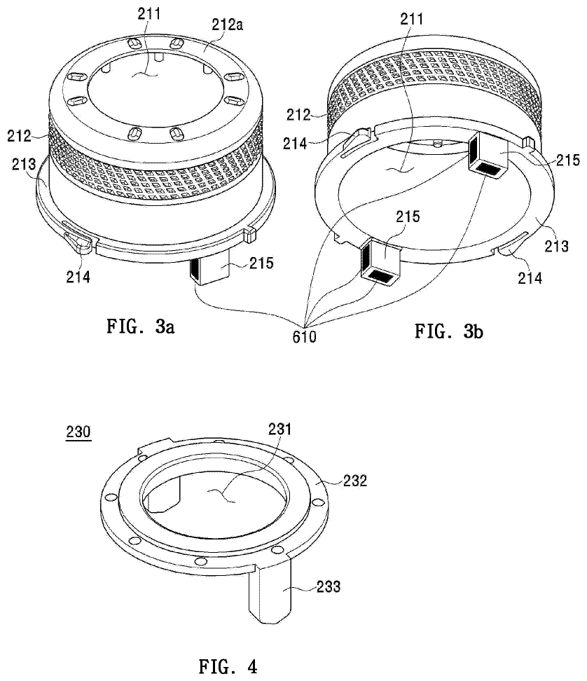

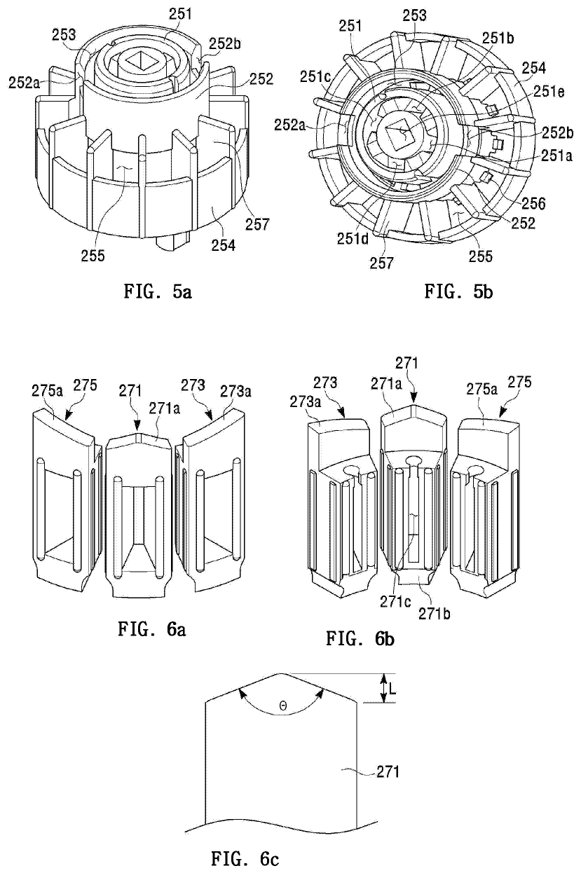

FIGS. 3A, 3B are views illustrating the dial knob 210 illustrated in FIG. 2, FIG. 4 is a view illustrating the rotary member 230 illustrated in FIG. 2, FIGS. 5A, 5B are views illustrating the button guide unit 250 illustrated in FIG. 2, and FIGS. 6A-6C are views illustrating the plurality of button units 270 illustrated in FIG. 2.

Referring to FIGS. 2 to 6A-6C, the dial assembly includes the dial knob 210, the rotary member 230, the button guide unit 250, and the button units 270.

The dial knob 210 may be rotated by the user. The dial knob 210 may be positioned at a predetermined reference position and rotated by a predetermined angle from the reference position.

The dial transmission lever device 10 according to the exemplary embodiment of the present invention may be configured such that the gear shift position (e.g., an R (Reverse) position, an N (Neutral) position, a D (Driving) positional, or the like) may be selected by the rotation of the dial knob 210, and the user may select the gear shift position by rotating the dial knob 210.

According to the exemplary embodiment, the dial knob 210 may be formed in a cylindrical shape.

The dial knob 210 may include a body portion 212 formed in a cylindrical shape, a blade portion 213 extending outward from a lower end of the body portion 212, and magnet receiving portions 215 disposed on a lower surface of the blade portion 213 and configured such that magnets 610 are disposed in the magnet receiving portions 215, respectively.

The dial knob 210 includes a hole 211 that penetrates the dial knob 210 from an upper side (one end) to a lower side (the other end) of the dial knob 210. Specifically, the dial knob 210 may have the hole 211 that penetrates the dial knob 210 in a direction along a rotation center axis of the dial knob 210. That is, the hole 211 may penetrate the body portion 212 and the blade portion 213 of the dial knob 210. The rotary member 230, the button guide unit 250, the button units 270, and the push assembly 300, which will be described below, may be disposed in the hole 211.

The body portion 212 may be formed in a cylindrical shape, and the hole 211 may penetrate the body portion 212 in the direction along the rotation center axis of the body portion 212.

The blade portion 213 may extend outward from the lower end of the body portion 212.

The dial knob 210 may have protrusions 214 that prevent a clearance.

Specifically, the protrusions 214 may be formed on the blade portion 213 of the dial knob 210.

When the dial knob 210 is disposed in the housing 100, there may be formed a clearance between the blade portion 213 of the dial knob 210 and a constituent element in the housing 100 that surrounds the blade portion 213. Because of the clearance, the dial knob 210 may sway while the dial knob 210 is rotated. In order to prevent the dial knob 210 from swaying due to the clearance, one or more protrusions 214 may be formed in a partial section of the blade portion 213 in order to prevent a clearance. The protrusion 214 may protrude from the blade portion 213 in a direction toward the constituent element disposed in the housing 100 that surrounds the blade portion 213.

The magnet receiving portion 215 may be disposed on the lower surface of the blade portion 213 and/or at the lower end of the body portion 212 and may have various shapes.

The magnet 610 of the detection unit to be described below is disposed in the magnet receiving portion 215, and a sensor (e.g., a Hall IC sensor) (not illustrated) of the detection unit may detect a magnetic field generated by the magnet 610.

The dial knob 210 may include the rotary member 230.

The rotary member 230 is disposed in the hole of the dial knob 210 and provided below an upper portion 212a of the dial knob 210. Specifically, the rotary member 230 is disposed in the hole 211 of the body portion 212 of the dial knob 210 and provided below the upper portion 212a of the body portion 212. Further, the plurality of button units 270 is disposed below the rotary member 230.

The rotary member 230 includes a ring portion 232 having a ring shape and having a hole 231 formed at a center of the ring portion 232.

The ring portion 232 may have, but not limited to, a circular shape, but may have various shapes. In addition, the ring portion 232 may have a flat surface or a surface including a curved or stepped portion.

The rotary member 230 is coupled to the dial knob 210. Specifically, the ring portion 232 of the rotary member 230 is disposed below the upper portion 212a of the body portion 212 of the dial knob 210 and coupled to the upper portion 212a of the body portion 212. The ring portion 232 may be coupled to the upper portion 212a of the body portion 212 by means of a bonding agent or a configuration in which protruding portions formed on an inner surface of the upper portion 212a of the body portion 212 are inserted into a plurality of holes or grooves (recesses) formed in the ring portion 232. In addition, various methods may be applied to couple the ring portion 232 and the upper portion 212a of the body portion 212.

Pressing portions 233 may be formed on the ring portion 232 of the rotary member 230. The pressing portion 233 may extend and protrude downward from a lateral surface of the ring portion 232. One or more pressing portions 233 may be provided. In a case in which the plurality of pressing portions 233 is provided, the pressing portions 233 may be disposed at predetermined intervals.

The pressing portion 233 may press the button unit 270. When the user rotates the dial knob 210, the rotary member 230 coupled to the dial knob 210 is rotated, and the rotation of the rotary member 230 allows the pressing portion 233 to press the button unit 270 disposed below the pressing portion 233.

As described above, the rotary member 230 and the dial knob 210 are separately manufactured and then coupled to each other. As an exemplary embodiment, the rotary member 230 and the dial knob 210 may be integrally formed.

The button guide unit 250 is disposed below the rotary member 230.

The button guide unit 250 is formed in a cylindrical tube shape and may have one side and the other side in a longitudinal direction thereof.

One side of the button guide unit 250 may have a multi-wall structure.

Specifically, one side of the button guide unit 250 may have an inner wall 251 and an outer wall 252. Each of the inner wall 251 and the outer wall 252 may have a flat surface or a surface including a curved or stepped portion.

One or more holes 251a to 251e are formed in the inner wall 251 in a longitudinal direction of the button guide unit 250, and a first light transmission member 350 to be described below is disposed in the one or more holes 251a to 251d. The one or more holes 251a to 251e penetrate one side and the other side of the button guide unit 250.

The outer wall 252 is disposed to surround the inner wall 251. The inner wall 251 and the outer wall 252 are disposed to be spaced apart from each other at a predetermined interval, such that a predetermined space 253 is formed between the inner wall 251 and the outer wall 252. One end of the inner wall 251 and one end of the outer wall 252 are connected to each other. Therefore, the predetermined space 253 formed between the inner wall 251 and the outer wall 252 may be a groove (recess).

A plurality of partition walls 257, which protrudes in a direction orthogonal to an outer surface (or outer circumferential surface) of the outer wall 252, may be formed in a partial section of the outer surface (or outer circumferential surface) of the outer wall 252. As an exemplary embodiment, sidewalls 254 may be formed to connect ends of the respective partition walls 257.

The plurality of partition walls 257 may be disposed at a predetermined constant interval, and the button unit 270 to be described below is disposed in a compartment 255 formed between one partition wall 257 and another partition wall 257 adjacent to one partition wall 257. The compartment 255 is a hole formed in the longitudinal direction of the button guide unit 250.

Catching/protruding portions 256 may be formed at the other side of the button guide unit 250. The catching/protruding portion 256 may be inserted into a groove (e.g., 271c) of the button unit 270 which is elongated in the longitudinal direction of the button unit 270. The button unit 270 may move vertically in a state in which the button unit 270 is caught by the catching/protruding portion 256.

The button unit 270 is disposed between one partition wall 257 and another partition wall 257 adjacent to one partition wall 257 formed on the outer wall 252 of the button guide unit 250. That is, the button unit 270 is disposed in the compartment 255.

The button unit 270 has a rod shape having a predetermined length and may have upper and lower portions in the longitudinal direction.

The groove (e.g., 271c), which is elongated in the longitudinal direction of the button unit 270, may be formed in one surface between the upper and lower portions of the button unit 270. The catching/protruding portion 256 of the button guide unit 250 is inserted and disposed into the groove (e.g., 271c).

The plurality of button units 270 is disposed in the plurality of compartments 255, respectively, and includes a first button unit 271, a second button unit 273, and a third button unit 275.

An arrangement relationship between the first button unit 271, the second button unit 273, and the third button unit 275 will be described. The first button unit 271 may be disposed at a middle portion, the second button unit 273 may be disposed to be spaced apart from one side of the first button unit 271 at a predetermined distance, and the third button unit 275 may be disposed to be spaced apart from the other side of the first button unit 271 at a predetermined distance. For example, the third button unit 275, the first button unit 271, and the second button unit 273 may be disposed in the direction from the left to the right.

The shapes of the first button unit 271, the second button unit 273, and the third button unit 275 will be described. An upper portion 271a of the first button unit 271 is formed in a triangular shape, an upper portion 273a of the second button unit 273 is formed to increase in height from the left to the right, and an upper portion 275a of the third button unit 275 is formed to decrease in height from the left to the right. Here, the height means a length from the upper portion (or one end) to the lower portion (or the other end) in the longitudinal direction of the button unit 270.

The upper portion of the first button unit 271 has a triangular shape, and a height L of the triangular shape is related to a stroke at which protruding portions 410 of the rubber unit 400 may be elastically deformed. For example, an angle θ of a vertex of the triangular shape increases as the height L of the triangular shape decreases. As the angle θ increases, the dial knob 210 may be more slowly returned after the dial knob 210 is rotated to select the gear shift position. Therefore, the shape of the upper portion of the first button unit 271 affects tension that may be generated in the protruding portions 410 of the rubber unit 400.

The lower portions (e.g., 271b) of the plurality of button units 270, that is, the lower portion of the first button unit 271, the lower portion of the second button unit 273, and the lower portion of the third button unit 275 may have the same shape.

Each of the plurality of button units 270 may have the groove (e.g., 271c) elongated in one surface in the longitudinal direction of the button unit 270 between the upper portion (e.g., 271a) and the lower portion (e.g., 271b) of the button unit 270. The catching/protruding portion 256 of the button guide unit 250 is inserted and disposed into the groove (e.g., 271c). The button unit 270 may move vertically in a state in which the button unit 270 is caught by the catching/protruding portion 256.

When the dial knob 210 is rotated, the rotary member 230 presses the button units 270, such that the button units 270 are moved downward. The button units 270 moved downward press the protruding portions 410 of the rubber unit 400. The pressed protruding portions 410 are elastically deformed and elastically restored, thereby creating operating feeling (sense of shifting gears).

Specifically, when the user rotates the dial knob 210, the rotary member 230 coupled to the dial knob 210 is rotated, and the rotation of the rotary member 230 allows the pressing portion 233 of the rotary member 230 to press the button unit 270 disposed below the pressing portion 233. In this case, in the state in which the button unit 270 is caught by the catching/protruding portion 256, the button unit 270 is moved downward and presses the protruding portion 410 of the rubber unit 400 which is disposed below the button unit 270. The protruding portion 410 of the rubber unit 400 is elastically deformed by being pressed, and the protruding portion 410 is elastically restored when the protruding portion 410 is not pressed. The elastic deformation and the elastic restoration of the protruding portion 410 of the rubber unit 400 provides the user with the operating feeling (sense of shifting gears).

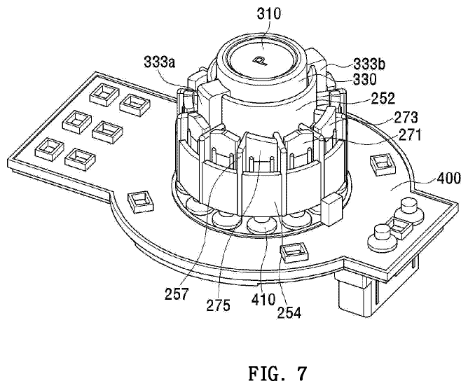

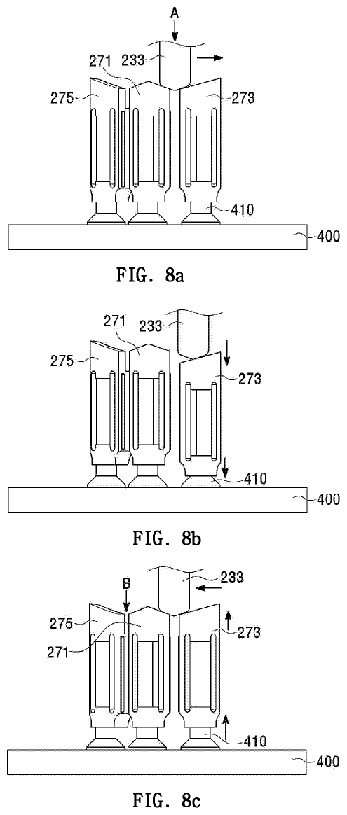

FIG. 7 is a view illustrating a state in which the rotary member 230, the button guide unit 250, and the plurality of button units 270, which are illustrated in FIG. 2, are combined, and FIGS. 8A-8C are views for explaining an operational principle of the dial assembly 200 illustrated in FIG. 2.

Referring to FIGS. 6A-6C to 8A-8C, a state in which an end of the pressing portion 233 of the rotary member 230 is disposed between the upper portion 271a of the first button unit 271 and the upper portion 273a of the second button unit 273 may be defined as a predetermined reference position (a first reference position, i.e., position A in FIGS. 8A-8C). The dial knob 210, which includes the rotary member 230 and is coupled to the rotary member 230, may be rotated in one direction from the first reference position A.

When the dial knob 210 and the pressing portion 233 of the rotary member 230 are rotated in one direction from the first reference position A, the pressing portion 233 of the rotary member 230 comes into contact with the upper portion 273a of the second button unit 273 and moves from the left to the right, thereby pressing the second button unit 273. The pressed second button unit 273 moves downward and presses the protruding portion 410 of the rubber unit 400 disposed below the second button unit 273, and the pressed protruding portion 410 is elastically deformed. Thereafter, when the protruding portion 410 is not pressed, the elastically deformed protruding portion 410 is elastically restored, such that elastic force is generated. The elastic force presses the second button unit 273 that has moved downward, so that the second button unit 273 moves upward. The second button unit 273, which is pressed by the elastic force, moves upward. The second button unit 273, which moves upward, allows the pressing portion 233 of the rotary member 230 placed on the upper portion 273a of the second button unit 273 to move from the right to the left. Therefore, the rotary member 230 and the dial knob 210 rotate in the reverse direction and return back to the first reference position A.

When the dial knob 210 and the pressing portion 233 of the rotary member 230 are rotated in the other direction (the direction opposite to one direction) from the first reference position A, the pressing portion 233 of the rotary member 230 comes into contact with the upper portion 271a of the first button unit 271 and moves from the right to the left, thereby pressing the first button unit 271 (in this case, the pressing portion 233 presses the upper portion 271a of the first button unit 271 while climbing over the triangular shape, that is, the upper portion 271a of the first button unit 271). The pressed first button unit 271 moves downward and presses the protruding portion 410 of the rubber unit 400 disposed below the first button unit 271, and the pressed protruding portion 410 is elastically deformed. Thereafter, when the protruding portion 410 is not pressed, the elastically deformed protruding portion 410 is elastically restored. In this case, the end of the pressing portion 233 of the rotary member 230 is disposed between the upper portion 271a of the first button unit 271 and the upper portion 275a of the third button unit 275.

The state in which the end of the pressing portion 233 of the rotary member 230 is disposed between the upper portion 271a of the first button unit 271 and the upper portion 275a of the third button unit 275 may be defined as another predetermined reference position (a second reference position, i.e., position B in FIGS. 8A-8C). The dial knob 210, which includes the rotary member 230 and is coupled to the rotary member 230, may be rotated in the other direction from the second reference position B.

When the dial knob 210 and the pressing portion 233 of the rotary member 230 are rotated in the other direction from the second reference position B, the pressing portion 233 of the rotary member 230 comes into contact with the upper portion 275a of the third button unit 275 and moves from the right to the left, thereby pressing the third button unit 275. The pressed third button unit 275 moves downward and presses the protruding portion 410 of the rubber unit 400 disposed below the third button unit 275, and the pressed protruding portion 410 is elastically deformed. Thereafter, when the protruding portion 410 is not pressed, the elastically deformed protruding portion 410 is elastically restored, such that elastic force is generated. The elastic force presses the third button unit 275 that has moved downward, so that the third button unit 275 moves upward. The third button unit 275, which is pressed by the elastic force, moves upward. The third button unit 275, which moves upward, allows the pressing portion 233 of the rotary member 230 placed on the upper portion 275a of the third button unit 275 to move from the left to the right. Therefore, the rotary member 230 and the dial knob 210 rotate in the reverse direction and return back to the second reference position B.

As described above, the operating feeling (sense of shifting gears) may be provided to the user by the process in which the first button unit 271, the second button unit 273, and the third button unit 275 are moved downward by the rotation of the dial knob 210 and the rotation of the rotary member 230 and the protruding portion 410 of the rubber unit 400 disposed below the button unit is elastically deformed and elastically restored.

According to the exemplary embodiment of the present invention, the first button unit 271, the second button unit 273, and the third button unit 275 are moved downward by the rotation of the dial knob 210 and the rotation of the rotary member 230, such that the protruding portion 410 of the rubber unit 400 disposed below the button unit may be elastically deformed. An electrical signal may be generated when the elastically deformed protruding portion comes into switch-contact with the board unit 500 (e.g., a printed circuit board) disposed below the rubber unit 400. The electrical signal may be electrically transmitted, and the gear shift position (e.g., the R (Reverse) position, the N (Neutral) position, and the D (Driving) position) may be selected in accordance with the rotation of the dial knob 210 and the rotation of the rotary member 230. The selected gear shift position may be displayed by means of the display window 113 formed on the upper housing 110.

<Push Assembly>

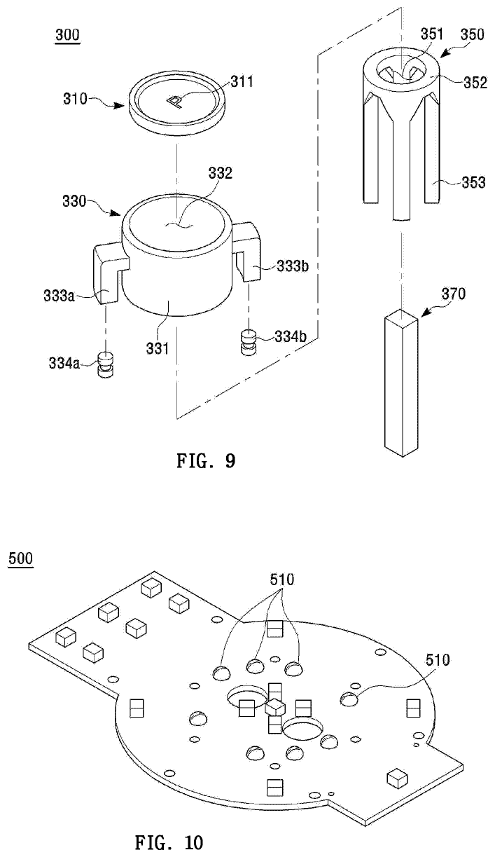

FIG. 9 is a view illustrating the push assembly 300 illustrated in FIG. 2.

Referring to FIGS. 1A, 1B, 3 to 5, and 7 and 9, the push assembly 300 is disposed in the hole 211 penetratively formed in the dial knob 210 and in the hole 231 penetratively formed in the rotary member 230.

The push assembly 300 includes the push unit 310, the push guide unit 330, and the damper units 334a and 334b.

The push unit 310 is exposed to the outside and disposed in a hole 332 that penetrates the push guide unit 330.

The push unit 310 may have a circular shape and may have a shape corresponding to a shape of the hole 332 that penetrates the push guide unit 330.

The push unit 310 may have a flat surface or a surface including a curved or stepped portion. The display window 311 may be provided on the flat surface or the surface including a curved or stepped portion of the push unit 310. When the push unit 310 is pressed, the gear shift position (e.g., the P (Parking) position) determined by the pressing operation may be displayed through the display window 311.

The push guide unit 330 may be a tubular portion 331 having a predetermined length and a cylindrical shape. Specifically, the tubular portion 331 of the push guide unit 330 includes the hole 332 that penetrates the tubular portion 331, and the push unit 310 is disposed in the hole 332. According to the exemplary embodiment of the present invention, the push unit 310 may be formed integrally with the push guide unit 330.

When the push unit 310 is pressed, the push unit 310, together with the push guide unit 330, may be moved downward. When the push unit 310 is not pressed, the push unit 310 and the push guide unit 330 may be moved upward together (i.e., the push unit 310 and the push guide unit 330 may return to the original position).

The push guide unit 330 includes catching portions 333a and 333b. Specifically, the plurality of catching portions 333a and 333b may be formed on an outer surface (or outer circumferential surface) of the tubular portion 331. The catching portions 333a and 333b protrude to the outside in a partial section of the outer surface (or outer circumferential surface) of the tubular portion 331, and each of the catching portions 333a and 333b may have a portion that extends downward from an end of the protruding portion. The plurality of catching portions 333a and 333b may be disposed at a predetermined constant interval.

The damper units 334a and 334b may be disposed below the catching portions 333a and 333b. Specifically, the damper units 334a and 334b may be disposed below the extending portions of the catching portions 333a and 333b. The damper units 334a and 334b may be disposed between the extending portions of the catching portions 333a and 333b and the button units 270 where the catching portions 333a and 333b are disposed.

When the push unit 310 is pressed, the damper units 334a and 334b transmit pressing force to the button units 270 disposed below the damper units 334a and 334b, such that the button units 270 are moved downward. The button unit 270, which moves downward, presses and elastically deforms the protruding portion 410 of the rubber unit 400 disposed below the button unit 270.

Specifically, when the push unit 310 is pressed, the push unit 310 and the push guide unit 330 are moved downward, and the catching portions 333a and 333b come into contact with the damper units 334a and 334b and press the damper units 334a and 334b. Therefore, the damper units 334a and 334b are also moved downward. The damper units 334a and 334b, which move downward, press the button units 270 disposed below the damper units 334a and 334b. The button unit 270 is moved downward by the pressing force, and the button unit 270 moved downward presses the protruding portion 410 of the rubber unit 400 disposed below the button unit 270. In this case, an electrical signal is generated when the protruding portion 410 is elastically deformed and comes into switch-contact with the board unit 500 disposed below the rubber unit 400. Based on the electrical signal, the gear shift position (e.g., the P (Parking) position) may be selected by the pressing operation of the push unit 310, and the selected gear shift position may be displayed through the display window 311.

The protruding portion 410 is elastically restored when the protruding portion is not pressed after the protruding portion 410 of the rubber unit 400 is elastically deformed by the pressing operation of the push unit 310. The elastic deformation and the elastic restoration of the protruding portion 410 of the rubber unit 400 provide the user with the operating feeling (sense of shifting gears). In addition, the elastic force is generated as the elastically deformed protruding portion 410 of the rubber unit 400 is elastically restored. The elastic force sequentially presses the button units 270 which move downward to press the protruding portions 410, and the elastic force presses the damper units 334a and 334b disposed on the button units 270, so that the button units 270 and the damper units 334a and 334b are moved upward. The pressed damper units 334a and 334b press the push guide unit 330 and the push unit 310 so that the push guide unit 330 and the push unit 310 move upward. Therefore, the push guide unit 330 and the push unit 310 may return to the original positions at which the push guide unit 330 and the push unit 310 are disposed before being pressed.

The damper units 334a and 334b serve to inhibit noise and vibration that may be generated when the push unit 310 is pressed. Each of the damper units 334a and 334b may be made of a rubber material or may be a spring.

The tubular portion 331 of the push guide unit 330 is disposed in the predetermined space 253 formed between the inner wall 251 and the outer wall 252 of the button guide unit 250, and the plurality of catching portions 333a and 333b of the push guide unit 330 is caught by the outer wall 252 of the button guide unit 250. In a case in which grooves 252a and 252b, which are opened upward, are formed in the outer wall 252 of the button guide unit 250, the catching portions 333a and 333b of the push guide unit 330 are disposed in the grooves 252a and 252b formed in the outer wall 252 of the button guide unit 250. In this case, the portions of the catching portions 333a and 333b, which extend downward, are disposed on an outer surface of the outer wall 252 of the button guide unit 250.

The push guide unit 330 may not be rotated together with the dial knob 210 and the rotary member 230 even though the dial knob 210 and the rotary member 230 are rotated. When the push unit 310 is pressed, the push guide unit 330 may be moved downward together with the push unit 310. When the push unit 310 is not pressed, the push guide unit 330 may be moved upward together with the push unit 310.

The push assembly 300 may further include the first light transmission member 350 and a second light transmission member 370.

Each of the first light transmission member 350 and the second light transmission member 370 is a kind of prism, that is, a member that transmits light.

The first light transmission member 350 is disposed below the push unit 310 and provided in the hole 332 that penetrates the push guide unit 330. In addition, the first light transmission member 350 is disposed in the inner wall 251 of the button guide unit 250.

The first light transmission member 350 includes a central connecting portion 352 formed with a through hole 351 and having a ring shape. The central connecting portion 352 may have, but not limited to, a circular shape, but may have various shapes such as an elliptical or polygonal shape.

Extension portions 353 may be formed on the central connecting portion 352 of the first light transmission member 350. The extension portion 353 may extend and protrude downward from a lateral or lower surface of the central connecting portion 352.

One or more extension portions 353 may be provided. In a case in which the plurality of extension portions 353 is provided, the plurality of extension portions 353 may be disposed at predetermined intervals.

The first light transmission member 350 is disposed in the inner wall 251 of the button guide unit 250. The one or more extension portions 353 of the first light transmission member 350 are disposed in the one or more holes 251a to 251d formed in the inner wall 251 of the button guide unit 250.

A through hole, which penetrates the rubber unit 400, is disposed below the extension portions 353 of the first light transmission member 350, and a light emitting element disposed on the board unit 500 is disposed below the through hole.

When the push unit 310 is pressed or a vehicle operates, the first light transmission member 350 transmits light, which is emitted from the light emitting element disposed on the board unit 500, to the push unit 310, such that the shape of the central connecting portion 352 of the first light transmission member 350 is displayed on the push unit 310.

The second light transmission member 370 is disposed below the push unit 310 and in the through hole 351 of the first light transmission member 350, and the second light transmission member 370 is disposed in the hole 251e formed in the inner wall 251 of the button guide unit 250.

The through hole, which penetrates the rubber unit 400, is disposed below the second light transmission member 370, and the light emitting element disposed on the board unit 500 is disposed below the through hole.

When the push unit 310 is pressed, the second light transmission member 370 transmits light, which is emitted from the light emitting element disposed on the board unit 500, to the display window 311, such that the gear shift position selected by the pressing operation of the push unit 310 may be displayed on the display window 311.

<Rubber Unit 400>

Referring to FIGS. 1A, 1B, 2, 7, and 8A-8C, the rubber unit 400 is disposed below the dial assembly 200 and the push assembly 300.

The rubber unit 400 may be made of a rubber material.

The rubber unit 400 include a plurality of through holes that penetrates the rubber unit 400.

The light emitted from the light emitting element disposed on the board unit 500 is transmitted while penetrating the plurality of through holes formed in the rubber unit 400, such that the gear shift position (e.g., the R (Reverse) position, the N (Neutral) position, the D (Driving) position, or the like) selected in accordance with the rotation of the dial knob 210 and the rotation of the rotary member 230 is displayed on the display window 113 formed on the upper housing 110.

Alternatively, the light emitted from the light emitting element disposed on the board unit 500 is transmitted to the push unit 311 while penetrating the through hole formed in the rubber unit 400, the first light transmission member 350, and/or the second light transmission member 370. The light, which penetrates the second light transmission member 370, is transmitted such that the gear shift position (e.g., the P (Parking) position) selected in accordance with the pressing operation of the push unit 310 is displayed on the display window 311 formed on the push unit 310.

The rubber unit 400 includes the plurality of protruding portions 410. The plurality of protruding portions 410 is disposed below the plurality of button units 270, respectively. The plurality of protruding portions 410 may provide the user with the operating feeling (sense of shifting gears) while being elastically deformed and elastically restored.

According to the exemplary embodiment of the present invention, the protruding portion 410 formed on the rubber unit 400 may be elastically deformed and may come into switch-contact with the board unit 500 disposed below the rubber unit 400. The electrical signal may be generated by the switch contact. Based on the electrical signal, the gear shift position (e.g., the R (Reverse) position, the N (Neutral) position, the D (Driving) position, the P (Parking) position, or the like) may be selected.

<Board Unit 500>

FIG. 10 is a view illustrating the board unit 500 illustrated in FIG. 2.

Referring to FIG. 10, the board unit 500 may be made by printing a circuit pattern on an insulator. Examples of the board unit 500 may include a typical printed circuit board (PCB), a metal core PCB, a flexible PCB, a ceramic PCB, and the like. In addition, the board unit 500 may be made by printing a circuit pattern with transparent or opaque resin. The resin may be a thin insulating sheet having the circuit pattern.

The board unit 500 may include the light emitting element (e.g., an LED module). When the dial knob 210 and the rotary member 230 are rotated and the gear shift position (e.g., the R (Reverse) position, the N (Neutral) position, the D (Driving) position, or the like) is selected, the light emitting element emits light, such that the selected gear shift position is displayed on the display window 113 provided on the upper housing 110. In addition, when the gear shift position (e.g., the P (Parking) position) is selected by the pressing operation of the push unit 310, the light emitting element emits light, such that the selected gear shift position may be displayed on the display window 311 provided on the push unit 310.

The board unit 500 may include the sensor (not illustrated). The sensor may be a Hall IC sensor. The sensor will be described together with the detection unit.

According to the exemplary embodiment of the present invention, the protruding portion 410 provided on the rubber unit 400 is elastically deformed by being pressed, such that the protruding portion 410 may come into switch-contact with the board unit 500 disposed below the rubber unit 400, and the electrical signal is generated by the switch contact. Based on the electrical signal, the gear shift position (e.g., the R (Reverse) position, the N (Neutral) position, the D (Driving) position, the P (Parking) position, or the like) may be selected.

The board unit 500 may be a metal dome sheet. The metal dome sheet may be made of stainless steel.

The metal dome sheet may include metal domes 510.

The metal dome 510 may be disposed below the protruding portion 410 of the rubber unit 400. Specifically, the metal dome 510 may be disposed on a portion of the board unit 500 which comes into switch-contact with the protruding portion 410 of the rubber unit 400.

The protruding portion 410 of the rubber unit 400 is disposed below the button unit 270 of the dial assembly 200, and the protruding portion 410 of the rubber unit 400 may be elastically deformed by being pressed and may come into switch-contact with the metal dome 510 of the board unit 500. The electrical signal may be generated by the switch contact, and the gear shift position may be selected based on the electrical signal.

The metal dome 510 may have a hemispheric shape. However, the shape of the metal dome 510 is not limited to the hemispheric shape but may have various shapes.

The metal dome sheet, which is the board unit 500, is formed in the form of a board and may serve as a flat spring by using elasticity of the board. Therefore, when the button unit 270 is pressed, the metal dome sheet, together with the protruding portion 410 of the rubber unit 400, may provide the driver with the operating feeling (sense of shifting gears) with elasticity of the board. In a case in which the metal dome sheet sufficiently provides the driver with the operating feeling (sense of shifting gears), the dial transmission lever device 10 according to the exemplary embodiment of the present invention may not have the rubber unit 400 or the protruding portion 410 of the rubber unit 400.

<Detection Unit>

Referring back to FIGS. 3A, 3B, the detection unit includes the magnet 610 disposed on the dial knob 210, and the sensor disposed on the board unit 500 and configured to detect a magnetic field of the magnet 610.

The magnet 610 is disposed in the magnet receiving portion 215 of the dial knob 210, and the sensor is disposed at a specific position on the board unit 500 which is spaced apart from the magnet 610 at a predetermined distance.

When the dial knob 210 is rotated, the magnet 610 disposed in the magnet receiving portion 215 is rotated, such that the magnetic field, which is to be detected by the sensor, is changed by the rotation of the magnet 610. The gear shift position of the vehicle may be selected by using a change in magnetic field detected by the sensor.

The magnet 610 may produce the magnetic field. The magnet 610 may be a permanent magnet or an electromagnet 610. In the case in which the magnet 610 is the electromagnet 610, intensity of the magnetic field produced by the magnet 610 may be adjusted depending on a magnitude of an electric current supplied to the magnet 610.

The sensor may measure the magnetic field that varies depending on the positions of the sensor relative to the magnet 610. Because the magnetic field, which is formed around the magnet 610, is decreased as the distance from the magnet 610 is increased, the measured value of the magnetic field may vary depending on the position at which the sensor measures the magnetic field even though the magnet 610 produces substantially the same magnetic field. The sensor may select the gear shift position of the vehicle by using the value measured in accordance with the change in magnetic field.

As an exemplary embodiment, the sensor may be a Hall integrated circuit (Hall IC) sensor. Based on the Hall effect, the Hall integrated circuit sensor may measure the intensity of the magnetic field.

As described above, the dial transmission lever device 10 according to the exemplary embodiment of the present invention may select the gear shift position of the vehicle by using the detection unit. Alternatively, the dial transmission lever device 10 may select the gear shift position of the vehicle by means of the switch contact between the rubber unit 400 and the board unit 500. Further, the detection unit and the switch contact may be used together to select the gear shift position of the vehicle. An advantage of a case in which the detection unit and the switch contact are used together is that even though one of the detection unit and the switch contact breaks down or has an error, the gear shift position of the vehicle may be selected by the other of the detection unit and the switch contact.

Referring back to FIGS. 1A, 1B, and 2, the dial transmission lever device 10 according to the exemplary embodiment of the present invention may include a mood member 130 and third light transmission members 150.

The mood member 130 is provided on an upper surface of the upper housing 110 and disposed in the hole 111.

The mood member 130 has a ring shape and is disposed on a portion of the upper housing 110 that forms the hole 111, and the dial knob 210 is penetratively disposed in the ring shape of the mood member 130. That is, the mood member 130 surrounds the body portion 212 of the dial knob 210 along the outer surface of the body portion 212 of the dial knob 210.

The mood member 130 may be made of glass or resin, or the mood member 130 may be made of various materials that emit light.

The third light transmission members 150 may be disposed below the mood member 130.

The third light transmission member 150 refers to a member such as a kind of prism that transmits light.

The through hole, which penetrates the rubber unit 400, is disposed below the third light transmission member 150, and the light emitting element disposed on the board unit 500 is disposed below the through hole.

When the gear shift position is selected as the dial knob 210 is rotated or the push unit 310 is pressed, the third light transmission member 150 may illuminate the mood member 130 by transmitting the light, which is emitted from the light emitting element disposed on the board unit 500, to the mood member 130.

The shape of the third light transmission member 150 is not particularly limited, but the third light transmission member 150 may have various shapes.

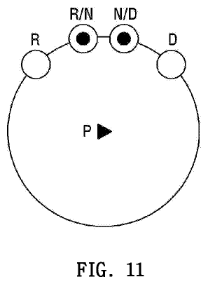

FIG. 11 is a view for explaining a pattern in which the gear shift position is selected by the operation of the dial knob 210 illustrated in FIG. 2.

FIGS. 8A-8C and 11 will be described below together.

For example, an R/N position (i.e., the N position) is made when the pressing portion 233 of the rotary member 230 is positioned at the first reference position A. When the dial knob 210 is rotated in one direction, the pressing portion 233 of the rotary member 230 comes into contact with the upper portion 273a of the second button unit 273 and moves (rotates) along the upper portion 273a of the second button unit 273 to press the second button unit 273, such that the R position is selected. Further, the dial knob 210 and the pressing portion 233 are returned back to the first reference position A and positioned at the R/N position (i.e., the R position). That is, the gear shift position is changed from the N position to the R position.

When the dial knob 210 is rotated in the other direction, the pressing portion 233 of the rotary member 230 moves (rotates) along the upper portion 271a of the first button unit 271, from the first reference position A to the second reference position B, the pressing portion 233 is positioned at the N/D position (in this case, the N position). That is, the gear shift position is changed from the R position to the N position.

When the dial knob 210 is rotated in the other direction from the N/D position (i.e., the N position), which is the second reference position B, the pressing portion 233 of the rotary member 230 comes into contact with the upper portion 275a of the third button unit 275 and moves (rotates) along the upper portion 275a of the third button unit 275 to press the third button unit 275, such that the D position is selected. Further, the dial knob 210 and the pressing portion 233 are returned back to the second reference position B and positioned at the N/D position (i.e., the D position). That is, the gear shift position is changed from the N position to the D position.

In order to change the gear shift position from the D position to the N position, the dial knob 210 is rotated in one direction, and the pressing portion 233 of the rotary member 230 switches from the second reference position B to the R/N position which is the first reference position A.

According to the dial transmission lever device 10 according to the exemplary embodiment of the present invention, the dial knob 210 is rotated by a predetermined angle, such that the operating feeling (sense of shifting gears) may be created by the rubber unit 400 or the metal dome sheet, and the gear shift position of the vehicle may be changed by the detection unit and/or the switch contact.

According to the present invention, since the dial knob 210 is rotated to select the gear shift position of the vehicle, the number of components of the product may be small, the product clearance may be small, and the product may be reduced in size.

The features, structures, effects, and the like described above in the exemplary embodiments are included in at least one exemplary embodiment of the present invention, but the present invention is not necessarily limited to one exemplary embodiment. Furthermore, the features, structures, effects, and the like described in the respective exemplary embodiments may be combined or modified and then carried out by those skilled in the art as another exemplary embodiment. It should be interpreted that the combination and modification are included in the scope of the present invention.

While the exemplary embodiments have been described above, but the exemplary embodiments are just illustrative and not intended to limit the present invention. It can be appreciated that various modifications and alterations, which are not described above, may be made to the present exemplary embodiment by those skilled in the art without departing from the intrinsic features of the present invention. That is, the respective constituent elements specifically described in the exemplary embodiments may be modified and then carried out. Further, it should be interpreted that the differences related to the modifications and alterations are included in the scope of the present invention defined by the appended claims.

What is claimed is:

1. A dial transmission lever device comprising:
a dial knob configured to be rotatable from a predetermined reference position and comprising a first hole that penetrates the dial knob from one end to the other end of the dial knob;
a button guide unit disposed in the dial knob;
a plurality of button units disposed in the button guide unit;
a rubber unit disposed below the button guide unit and comprising protruding portions disposed below the plurality of button units, respectively; and
a board unit disposed below the rubber unit,
wherein the dial knob comprises a rotary member disposed in the first hole, coupled to the dial knob, and rotates together with the dial knob, and
wherein when the dial knob is rotated, the rotary member presses the button unit, the button unit is moved downward, the button unit moved downward presses the protruding portion of the rubber unit, and the pressed protruding portion is elastically deformed and comes into switch-contact with the board unit disposed below the rubber unit, such that an electrical signal is generated, and a gear shift position of a vehicle is selected based on the electrical signal.

2. The dial transmission lever device of claim 1, wherein the pressed protruding portion is elastically deformed and elastically restored to create operating feeling.

3. A dial transmission lever device comprising:
a dial knob configured to be rotatable from a predetermined reference position and comprising a first hole that penetrates the dial knob from one end to the other end of the dial knob;
a button guide unit disposed in the dial knob;
a plurality of button units disposed in the button guide unit;
a rubber unit disposed below the button guide unit and comprising protruding portions disposed below the plurality of button units, respectively;
a board unit disposed below the rubber unit; and
a detection unit comprising a magnet disposed on the dial knob, and a sensor disposed on the board unit and configured to detect a magnetic field of the magnet,
wherein when the dial knob is rotated, the magnet disposed on the dial knob is rotated, a magnetic field detected by the sensor changes in accordance with the rotation of the magnet, and a gear shift position of a vehicle is selected by using the change in detected magnetic field.

4. The dial transmission lever device of claim 3, wherein the dial knob comprises a rotary member disposed in the first hole, coupled to the dial knob, and configured to rotate together with the dial knob, and
wherein when the dial knob is rotated, the rotary member presses the button unit, the button unit moves downward, the button unit moved downward presses the protruding portion of the rubber unit, and the pressed protruding portion is elastically deformed and elastically restored to create operating feeling.

5. The dial transmission lever device of claim 1, wherein the button guide unit comprises an inner wall and an outer wall,
wherein one or more holes, which penetrate the button guide unit in a longitudinal direction of the button guide unit, are formed in the inner wall,
wherein the outer wall is formed to surround the inner wall and disposed to be spaced apart from the inner wall at a predetermined interval so that a groove is formed between the inner wall and the outer wall,
wherein a plurality of partition walls, which protrudes in a direction orthogonal to an outer surface of the outer wall, is formed in a partial section of the outer surface of the outer wall, and
wherein the plurality of partition walls is disposed constantly at predetermined intervals, and the button unit is disposed between one partition wall and another partition wall adjacent to one partition wall.

6. The dial transmission lever device of claim 2, wherein the plurality of button units comprises a first button unit, and a second button unit disposed to be spaced apart from one side of the first button unit at a predetermined distance, an upper portion of the first button unit is formed in a triangular shape, and an upper portion of the second button unit is increased in height from the left to the right, and
wherein when a pressing portion of the rotary member is disposed between the upper portion of the first button unit and the upper portion of the second button unit and the dial knob is rotated in one direction, the pressing portion comes into contact with the upper portion of the second button unit and moves from the left to the right to press the second button unit, the pressed second button unit moves downward, the second button unit moved downward presses the protruding portion of the rubber unit disposed below the second button unit, and the pressed protruding portion is elastically deformed and then elastically restored.

7. The dial transmission lever device of claim 6, wherein the plurality of button units further includes a third button unit disposed to be spaced apart from the other side of the first button unit at a predetermined distance, and the upper portion of the third button unit is decreased in height from the left to the right, and
wherein when the pressing portion of the rotary member is disposed between the upper portion of the first button unit and the upper portion of the third button unit and the dial knob is rotated in the other direction, the pressing portion comes into contact with the upper portion of the second button unit and moves from the right to the left to press the third button unit, the pressed third button unit moves downward, the third button unit moved downward presses the protruding portion of the rubber unit disposed below the third button unit, and the pressed protruding portion is elastically deformed and then elastically restored.

8. The dial transmission lever device of claim 1, further comprising:
a push assembly disposed in the first hole of the dial knob,
wherein the push assembly comprises:
a push unit exposed to the outside;
a push guide unit comprising a second hole in which the push unit is disposed, the push guide unit being disposed in the button guide unit and configured to move vertically together with the push unit; and
a damper unit disposed below a catching portion of the push guide unit, and
wherein when the push unit is pressed, the push unit and the push guide unit move downward, the catching portion comes into contact with the damper unit to press the damper unit, the pressed damper unit moves downward to press the button unit disposed below the damper unit, the pressed button unit moves downward to press the protruding portion of the rubber unit disposed below the button unit, and the pressed protruding portion is elastically deformed and comes into switch-contact with the board unit disposed below the rubber unit, such that an electrical signal is generated, and a gear shift position is selected by the pressing operation of the push unit based on the electrical signal.

9. The dial transmission lever device of claim 8, wherein the push assembly further comprises a first light transmission member or a second light transmission member, the first light transmission member is disposed below the push unit and disposed in the second hole of the push guide unit, the second light transmission member is disposed below the push unit and disposed in a through hole of the first light transmission member,
wherein when the push unit is pressed or the vehicle operates, the first light transmission member transmits light, which is emitted from a light emitting element disposed on the board unit, to the push unit, and
wherein when the push unit is pressed, the second light transmission member transmits light, which is emitted from the light emitting element disposed on the board unit, to a display window of the push unit, such that a gear shift position made by the pressing operation of the push unit is displayed on the display window.

10. The dial transmission lever device of claim 1, wherein the board unit is a metal dome sheet comprising a metal dome, and the metal dome is disposed below the protruding portion of the rubber unit, and
wherein when the metal dome is pressed as the pressed protruding portion is elastically deformed, the protruding portion and the metal dome come into switch-contact with each other, such that an electrical signal is generated, and a gear shift position designated for the button unit is selected by the electrical signal.

11. The dial transmission lever device of claim 10, wherein the metal dome sheet creates operating feeling by elasticity of a board when the button unit is pressed.

12. The dial transmission lever device of claim 1, wherein one or more protrusions configured to prevent a clearance are formed on the dial knob.

13. The dial transmission lever device of claim 1, further comprising:
a mood member; and
a third light transmission member disposed below the mood member, wherein the mood member is disposed in a hole formed in an upper surface of a housing, the mood member has a ring shape, and the dial knob is penetratively disposed in the ring shape,
wherein when a gear shift position of the vehicle is selected, the third light transmission member transmits light, which is emitted from a light emitting element disposed on the board unit, to the mood member to illuminate the mood member.
